(19) United States
(12) Patent Application Publication
(10) Pub. No.: US 2012/0317865 A1
(43) Pub. Date: Dec. 20, 2012

(54) REVERSE GEAR BOX DEVICE

(76) Inventor: Wesley Seigler, Reedville, VA (US)

(21) Appl. No.: 13/526,040

(22) Filed: Jun. 18, 2012

Related U.S. Application Data
(60) Provisional application No. 61/498,208, filed on Jun. 17, 2011.

(51) Int. Cl. A01K 89/06; A01K 87/00

(52) U.S. Cl. 43/18.1 R; 242/255

(57) ABSTRACT

A reverse gear box device is disclosed that provides an ergonomic fit while making it easy to access a drag lever. The reverse gear box device is configured to fit ergonomically in the hand of a user, allowing for secure and comfortable grip of the gear box device, regardless of whether the drag lever is located in an engagement position or a maximum drag position. The reverse gear box device comprises a reel unit having a center point, where the reel unit is configured to releasably hold a fishing line, a housing that is attached to the reel unit, the housing have a first end that is near said center point and a second end that is opposite from said first end, and a drag lever that is connected to at least one of the reel unit and the housing, wherein the second end of the housing is located aft a perpendicular centerline that is formed between said center point and a pole longitudinal axis at an angle of about 90° with respect to the pole longitudinal axis.

### CROSS-REFERENCE TO PRIOR APPLICATIONS

This application claims priority under 35 U.S.C. §119(e) to U.S. Provisional Patent Application No. 61/498,208, filed Jun. 17, 2011, and titled “REVERSE GEAR BOX DEVICE,” the disclosure of which is hereby expressly incorporated by reference herein in its entirety.

### FIELD OF THE DISCLOSURE

The present disclosure relates to a gear box device. More particularly, the disclosure relates to a reverse gear box device that facilitates easy access to an engaging drag lever and fits ergonomically in user's hand.

### BACKGROUND OF THE DISCLOSURE

Fishing reels are generally grouped into two main categories—conventional reels and spinning reels. In conventional reels, a transversely mounted spool is held for rotation in a housing and the fishing line fed from the spool is affected only by the appropriate rotation of the spool. Because the spool must rotate as fishing line is fed from the spool, the inherent inertia and resistance to rotation of the spool, coupled with rapid line removal during a cast, limits the casting distance capability of the fishing reels.

Spinning reels were developed to improve the casting capability provided by conventional reels. Spinning reels generally comprise a separate rotatable housing which includes a pivotally mounted two-position bail arrangement. In its closed position, the bail feeds the line around and onto the spool when the handle of the reel is rotated. In its open position, the line on the spool is completely free of the bail and may be pulled off of the spool without interference and without movement from any part of the fishing reel. The open-bail position, therefore, greatly enhances the castability of such fishing reels.

Most spinning reels incorporate a drag mechanism comprising a knob and/or lever that allows a user of the fishing reel to give the rotation of the spool a desired resistance (corresponding to the durability of the fishing line) to avoid snapping the line when it is subjected to varying loads. The knob and/or lever of most drag mechanisms, however, are difficult to access and manipulate when the spinning reels are held by anglers.

### SUMMARY OF THE DISCLOSURE

Accordingly, one non-limiting aspect of the disclosure relates to a gear box device comprising a drag lever that is easy to access and manipulate when the gear box device is held by an angler. The gear box device is configured to fit ergonomically in the hand of a user, allowing for secure and comfortable grip of the gear box device.

More particularly, the disclosure provides a reverse gear box device that includes a drag lever which is easy to access and manipulate. The disclosure also provides a gear box device that has an ergonomic configuration that fits securely and comfortably in the hand of a user, allowing for easy access and manipulation of the drag lever from a first position to a second position, or from the second position to the first position.

The reverse gear box device comprises: a reel unit having a center point, where the reel unit is configured to releasably hold a fishing line; a housing having a rotation point, where the housing is attached to the reel unit, the housing have a first end that is near said center point and a second end that is opposite from said first end; and a drag lever that is connected to at least one of the reel unit and the housing, wherein the drag lever is configured to move between an engagement stop position and a maximum drag position, wherein said second end of the housing is located aft a perpendicular centerline that is formed between said center point and a pole longitudinal axis at an angle of about 90° with respect to the pole longitudinal axis, wherein the second end of the housing is configured to be positioned in or near fulcrum of a user's hand when the gear box device is mounted to a pole and held by the user, and wherein said rotational point is located along a housing centerline, which is formed between the rotational point and said center point. The housing centerline may be located at an angle of about 43.5° aft said perpendicular centerline.

Additional features, advantages, and embodiments of the disclosure may be set forth or apparent from consideration of the detailed description and drawings. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of an existing gear box having a drag lever located in a first position;

FIG. 2 shows a side view of the gear box of FIG. 1 with drag lever located in a second position for maximum drag;

FIG. 3 shows a schematic view of the gear box of FIG. 1;

FIG. 4 shows an example of a reverse gear box device that is constructed according to principles of the disclosure, wherein a drag lever is located in a first position;

FIG. 5 shows a side view of the reverse gear box device of FIG. 4, wherein the drag lever is located in a second position for maximum drag; and

FIG. 6 shows a schematic view of the reverse gear box device of FIG. 4.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

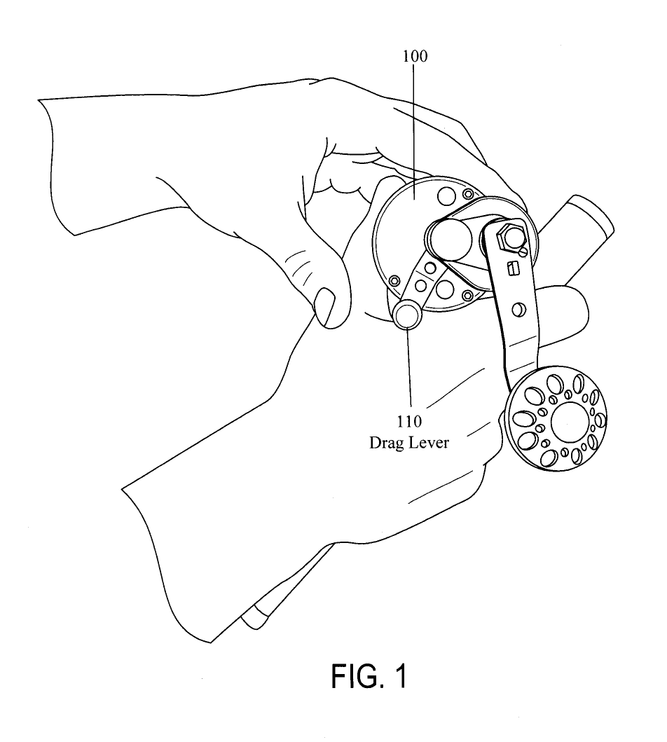

FIG. 1 shows an example of an existing gear box device 100 having a drag lever 110 that is located in a first (or hand-fulcrum) position. The hand-fulcrum position is located such that when the gear box device 100 is fixed to, e.g., a pole and held by a user, the drag lever 110 (when in the engagement stop position) is located at the fulcrum of the user's hand, as seen in the illustration.

As seen in FIG. 1, the drag lever 110 is difficult to access and manipulate when, for example, the pole is held in hand and the drag lever 110 is located at, or near the engagement stop position (shown in FIG. 1). Thus, after (or as) a user casts a line, the user may need to remove his/her right hand (or left hand for a left-handed gear box device, not shown) from the pole and gear box device 100 to be able to manipulate the drag lever 110 to a different drag setting. Further, because the user's hand may be in the way for part of the range of settings for the drag lever 110 (e.g., the thumb may get in the way), the user may not be able to use the full range of position settings for the drag lever 110, thereby limiting the operational range of drag settings for the drag lever 110.

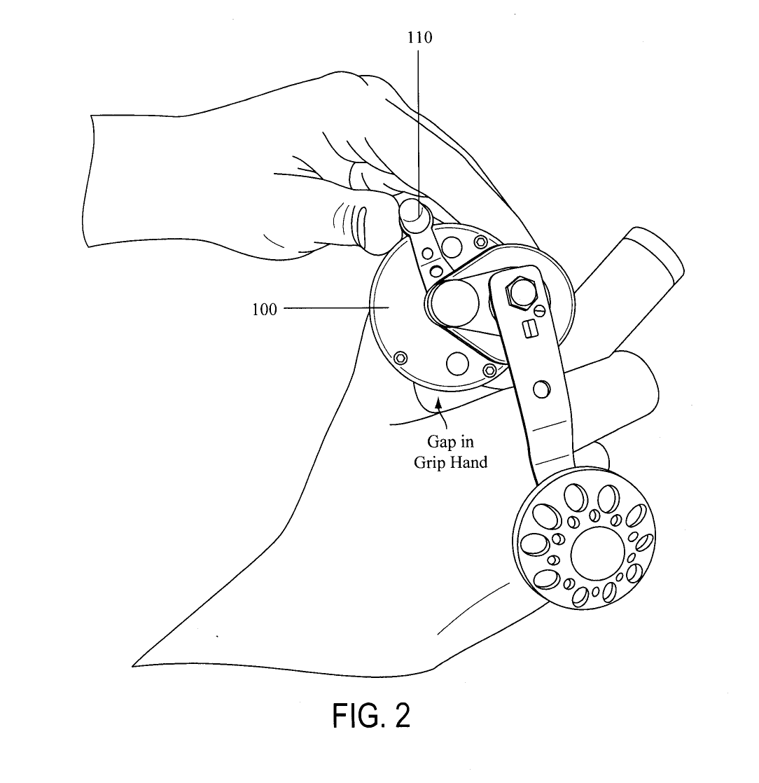

FIG. 2 shows the gear box device 100 of FIG. 1, wherein the drag lever 110 is located at, or near a maximum drag stop position to provide maximum drag. As seen in FIG. 2, a gap is formed at the fulcrum of the user's hand—that is, between the user's hand and the gear box device 100 when the drag lever 110 is moved toward the maximum drag stop position. The gap is similarly formed for most of the settings for the drag lever 110 as it moves from the engagement stop position to the maximum drag stop position of the gear box device 100.

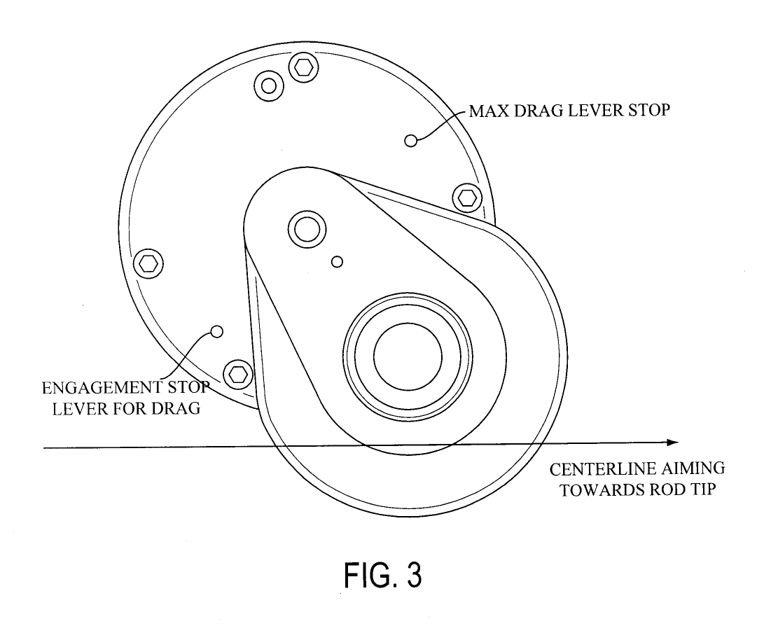

FIG. 3 shows a schematic view of the gear box device 100 mounted to a fishing pole. As seen in FIG. 3, the gear box device 100 has a configuration that, when mounted to fishing the pole, causes a gap to form between a user's hand and the gear box device 100 during use.

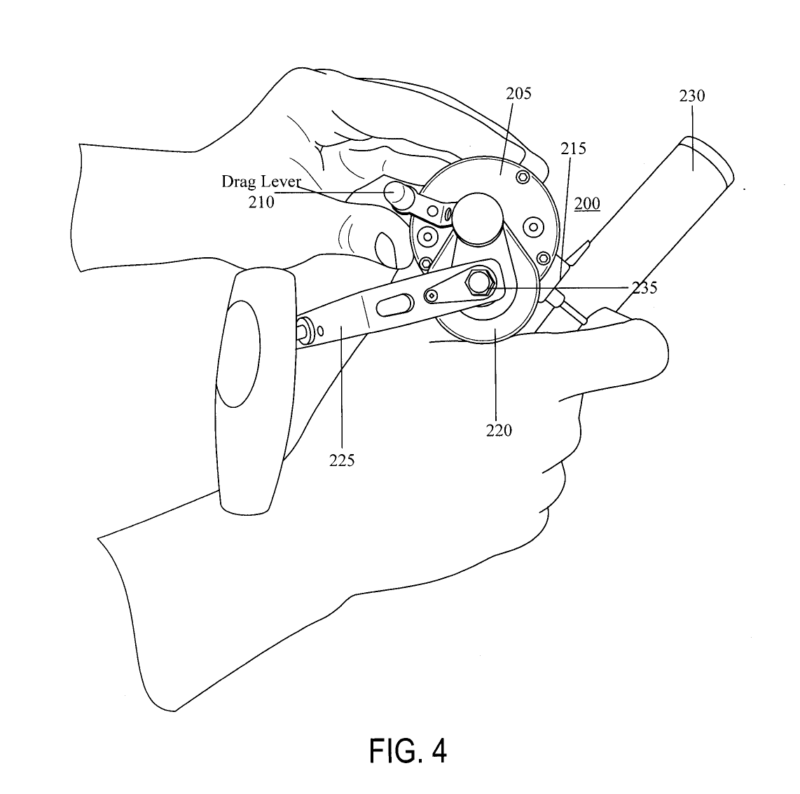

FIG. 4 shows an example of a reverse gear box device 200 that is constructed according to principles of the disclosure. The reverse gear box device 200 comprises a reel unit 205, a drag lever 210, a mount 215, a housing 220, and a handle assembly 225. The handle assembly 225 may be affixed to the housing 220 and configured to rotate about a rotation point 235. The reverse gear box device 200 may be affixed to a pole (or rod) 230 by means of the mount 215 and a fastening mechanism, such as, for example, a clip, a screw, a bolt, a nut, a pin, a clamp, or the like. The drag lever 210 and the handle assembly 225 may be attached to the housing 220. The housing 220 may be attached to or integrally formed with the reel unit 205.

The reel unit 205 may be configured to releasably hold a fishing line, which may vary in weight and/or strength. The fishing line may be, for example, rolled into or onto the reel unit 205. Also, the fishing line may be, for example, rolled out from or off of the reel unit 205. The reel unit 205 may be configured to receive an assembled roll (not shown) of fishing line.

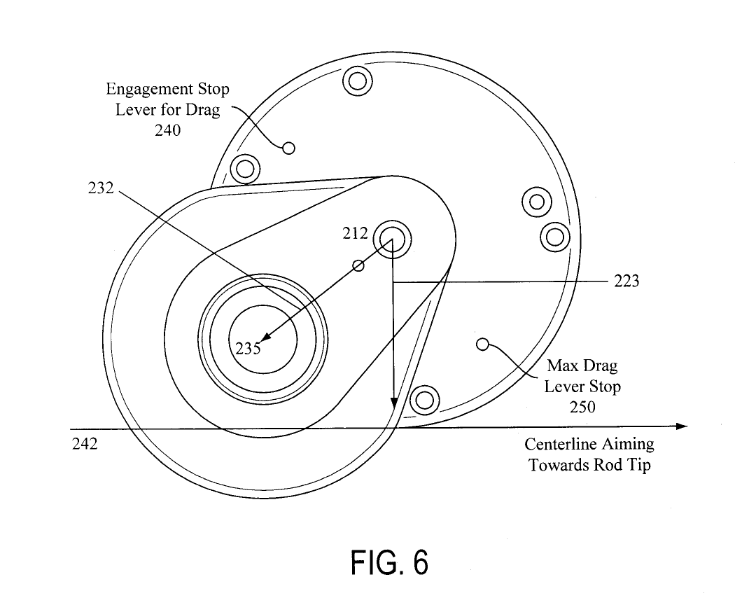

As seen in FIG. 4, the housing 220 is located in the fulcrum position and the engagement stop position 240 (shown in FIG. 6) of the drag lever 210 is located substantially away from the fulcrum position. Accordingly, when the pole 230 and reverse gear box device 200 are grasped by the user's hand, the housing 220 is located in or near the fulcrum of the user's hand. This configuration facilitates, inter alia, better and more comfortable grip by the user, better control by the user, and better response time, since the user's hand may be located in an optimal position during line casting, while allowing for simultaneous manipulation of the drag lever 210 over the full range of its settings.

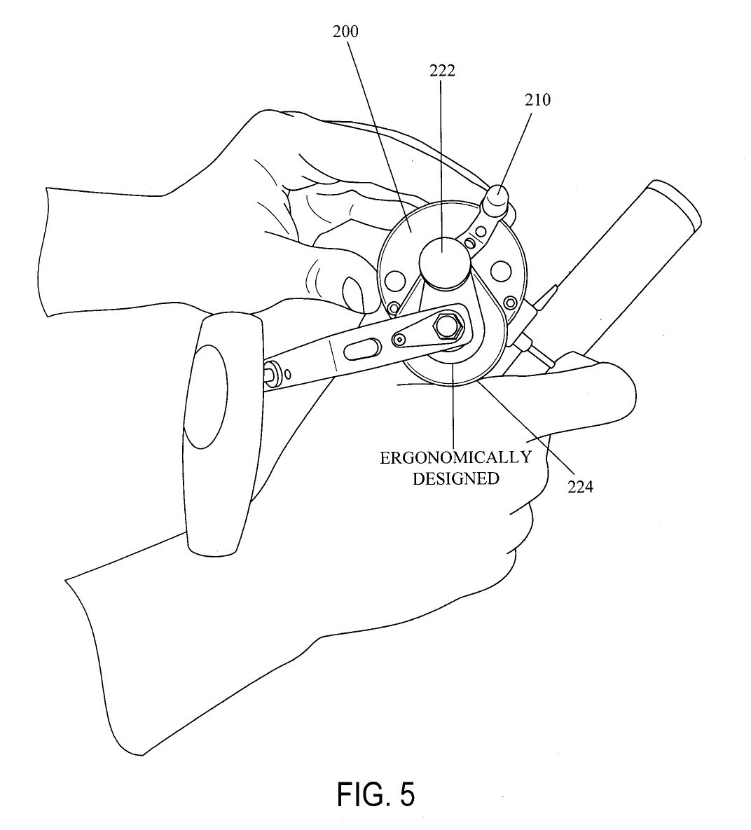

FIG. 5 shows an example of the reverse gear box device 200 having the drag lever 210 set to, or substantially set to the maximum drag stop position 250, providing maximum drag to the reel unit 205.

Referring to FIG. 6, in one aspect of the disclosure, the reverse gear box device 200 may be configured so that when the reverse gear box device 200 is attached to the fishing pole 230, a center point 212 of the reverse gear box device 200 is located substantially perpendicular to a pole longitudinal axis 242, along which the pole 230 may be located, forming a perpendicular centerline 223 there-between. Further, the housing 220 may be configured so that the rotational point 235 (shown in FIGS. 4-6) may be located along a housing centerline 232 that is about, for example, 43.5° aft the perpendicular centerline 223. The housing 220 may have other configurations without departing from the scope or spirit of the disclosure, such as, for example, where the rotational point 235 is located anywhere from about, for example, 20 degrees to about 45 degrees behind the center point. aft the perpendicular centerline 223.

FIG. 5 shows the reverse gear box device 200, wherein the drag lever 210 is located in at, or near the maximum drag stop position 250. As seen in FIG. 5, the configuration of the reverse gear box device 200 provides for an ergonomic fit, even when the drag lever 210 is located in, or near the maximum drag stop position 250.

The housing 220 may have any shape, including, for example, a tear drop, having a narrow dimension at an end 222 proximate the center point 212 and a wide dimension at an end 224 opposite the end 222 proximate the center point 212. Furthermore, the housing 220, as well as the reel unit 205, the drag lever 210, the mount 215, and/or the handle assembly 225 may be made from any suitable material, including, for example, metal, plastic, carbon-fiber, and the like.

As seen in FIGS. 4-6, the end 224 of the housing 220 is oriented away from the perpendicular centerline 223, toward the base of the pole 230 (not shown) when the reverse gear box device 200 is mounted to the pole 230—that is, towards the user's hand. The resulting reverse gear box device 200 provides for a drag lever 210 that is easy to access and manipulate, providing for an ergonomic fit that allows for a secure grip of the fishing pole 230 and reverse gear box device 200 by the user.

The reverse gear box device 200, as noted earlier, may comprise the engagement (or free spool) stop position 240 that may be located to the left end of the perpendicular centerline 223. The gearbox device 200 may further comprise the maximum (or full) drag stop position 250 located to the right of the perpendicular centerline 223. The drag lever 210 is typically configured and arranged to travel between the engagement stop position 240 and the maximum drag stop position 250 during operation of the reel unit 205, so that drag may be caused by or generated in response to the position of the drag lever 210, increasing drag (or pressure on the reel unit 205) as the drag lever 210 pivots (or travels) from the engagement stop position 240 towards the maximum drag stop position 250.

The drag leer 210 may be connected to the reel unit 205 and/or the housing 220. The drag lever 210 may comprise a knob or handle device to allow a user to more easily manipulate the drag lever 210. The drag lever 210 may be configured to regulate the free spool mechanism (not shown) in the reel unit 205, thereby allowing a user to control the pressure applied to the spool mechanism by moving the drag lever 210 from the engagement stop position 240 to the maximum drag stop position 250, or vis-a-versa. For example, the drag lever 210 may be manipulated to move from the engagement stop position 240 (e.g., moving from minimal pressure being applied to the spool mechanism) to the maximum drag stop position (e.g., where maximum pressure is applied to the spool mechanism). The drag lever 210 may be configured to regulate the pressure in increments, so as to provide the user with greater and more precise control of the pressure applied to the spool mechanism. In this regard, the reverse gear box device 200 may include a plurality of discrete positions between the engagement stop position 240 and the maximum drag stop position 250.

According to a further aspect of the disclosure, a system is disclosed that comprises the reverse gear box 200 and the fishing pole 230.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed:

1. A reverse gear box device, comprising:
a reel unit having a center point, where the reel unit is configured to releasably hold a fishing line;
a housing having a rotation point, where the housing is attached to the reel unit, the housing have a first end that is near said center point and a second end that is opposite from said first end; and
a drag lever that is connected to at least one of the reel unit and the housing, wherein the drag lever is configured to move between an engagement stop position and a maximum drag position,
wherein said second end of the housing is located aft a perpendicular centerline that is formed between said center point and a pole longitudinal axis at an angle of about 90° with respect to the pole longitudinal axis,
wherein the second end of the housing is configured to be positioned in or near fulcrum of a user's hand when the gear box device is mounted to a pole and held by the user, and
wherein said rotational point is located along a housing centerline, which is formed between the rotational point and said center point.

2. The reverse gear box device according to claim 1, wherein the housing centerline is located at an angle of about 43.5° aft said perpendicular centerline.

3. A reverse gear box device, comprising:
a reel unit having a center point, where the reel unit is configured to releasably hold a fishing line;
a housing that is attached to the reel unit, the housing have a first end that is near said center point and a second end that is opposite from said first end;
a drag lever that is connected to at least one of the reel unit and the housing,
wherein said second end of the housing is located aft a perpendicular centerline that is formed between said center point and a pole longitudinal axis at an angle of about 90° with respect to the pole longitudinal axis.

4. The reverse gear box device according to claim 3, wherein the drag lever is configured to move between an engagement stop position and a maximum drag position.

5. The reverse gear box device according to claim 3, wherein the second end of the housing is configured to be positioned in or near fulcrum of a user's hand when the gear box device is mounted to a pole and held by the user.

6. The reverse gear box device according to claim 3, wherein the housing comprises a rotational point.

7. The reverse gear box device according to claim 6, wherein said rotational point is located along a housing centerline, which is formed between the rotational point and said center point.

8. The reverse gear box device according to claim 7, wherein the housing centerline is located at an angle of about 43.5° aft said perpendicular centerline.

9. A reverse gear box device, comprising:
a reel unit having a center point, where the reel unit is configured to releasably hold a fishing line; and
a housing that is attached to the reel unit, the housing have a first end that is near said center point and a second end that is opposite from said first end,
wherein said second end of the housing is located aft a perpendicular centerline that is formed between said center point and a pole longitudinal axis at an angle of about 90° with respect to the pole longitudinal axis.

10. The reverse gear box device according to claim 9, gear box device further comprises:
a drag lever that is connected to at least one of the reel unit and the housing.

11. The reverse gear box device according to claim 10, wherein the drag lever is configured to move between an engagement stop position and a maximum drag position.

12. The reverse gear box device according to claim 9, wherein the second end of the housing is configured to be positioned in or near fulcrum of a user's hand when the gear box device is mounted to a pole and held by the user.

13. The reverse gear box device according to claim 9, wherein the housing comprises a rotational point.

14. The reverse gear box device according to claim 13, wherein said rotational point is located along a housing centerline, which is formed between the rotational point and said center point.

15. The reverse gear box device according to claim 14, wherein the housing centerline is located at an angle of about 43.5° aft said perpendicular centerline.

16. A pole system comprising the reverse gear box device according to claim 1 and a fishing pole.

17. A pole system comprising the reverse gear box device according to claim 3 and a fishing pole.

18. A pole system comprising the reverse gear box device according to claim 9 and a fishing pole.
